(19) United States
(12) Patent Application Publication
(10) Pub. No.: US 2013/0030757 A1
(43) Pub. Date: Jan. 31, 2013

(54) METHOD FOR RECONSTRUCTING THE INTERNAL STRUCTURE OF A SAMPLE BODY BY MEANS OF REFLECTION AND SCATTERING SIGNALS

(71) Applicants: Rainer Stotzka, Karlsruhe (DE); Nicole Ruiter, Karlsruhe (DE)

(72) Inventors: Rainer Stotzka, Karlsruhe (DE); Nicole Ruiter, Karlsruhe (DE)

(73) Assignee: KARLSRUHER INSTITUT FUR TECHNOLOGIE, Karlsruhe (DE)

(21) Appl. No.: 13/639,767

(22) PCT Filed: Apr. 7, 2011
(86) PCT No.: PCT/EP11/01733

§ 371 Date: Oct. 5, 2012

(30) Foreign Application Priority Data
Apr. 8, 2010 (DE) 102010014166.6-51

(51) Int. Cl. G01B 15/00; G06F 15/00

(52) U.S. Cl. 702/156

(57) ABSTRACT

One aspect of the invention relates to a method for reconstructing the spatial distribution of a reflection coefficient for waves in a sample body, comprising the following steps: parameterizing the sample body by means of N volume elements; determining M different measurement configurations of an emitting device and an associated receiving device; defining the number T of measurement points; setting up M path matrices G^{[i]}, wherein the possible paths of reflected or scattered waves are encoded in the i-th path matrix; registering M series of measurements, wherein an excitation signal a^{[i]} is fed to the emitting device in the i-th series of measurements, and the associated receiving device (5) registers a series of measurements x^{[i]}; calculating a predictive differential vector Δx=x−G·s^{[n]}, which contains the difference between the elements of the M registered series of measurements x^{[i]}ₜ and the predictable series of measurements G^{[i]}ₜⱼ·s^{[n]}ⱼ; minimizing a norm of the predictive differential vector ∥Δx∥; and providing the reflection coefficients s^{[n]}. The invention also relates to an apparatus for carrying out the method.

The invention relates to a method and an apparatus for determining the internal structure of a sample body by means of reflection signals or scattered signals. In particular, the invention relates to the reconstruction of the spatial distribution of a reflection coefficient for waves in a sample body.

A plurality of imaging methods for determining the internal structure of sample bodies is known. These imaging methods are based on physical measurement methods, in which a physical interaction of an excitation signal with the internal structure of the sample body results in measurable data. For example, wave-mechanical interactions, such as reflections or scattering events, of the sample body with at least one excitation wave can be measured. Here, the wave-mechanical interaction of the sample body is substantially affected by a heterogeneous distribution of the wave propagation properties of the sample body, such as the wave propagation velocity, the impedance, or the attenuation. As an excitation wave, both mechanical waves, such as compression waves, shear waves, sound waves or ultrasonic waves, and electromagnetic waves, such as light waves, radar waves, microwaves or X-rays, can be used. Based on the assumption that the spatial distribution of the reflection coefficient is correlated with the desired spatial structure, the determination of the internal structure is successful.

For determining a two-dimensional or three-dimensional structure of the interior of the sample body, detecting a plurality of series of measurements having different measurement configurations is required as a rule, wherein the excitation wave takes a different route through the interior of the sample body in each of the measurement configurations. The implementation of an imaging method based on the obtained series of measurements typically involves the solution of an inverse problem, which is usually solved by an approximation using methods of linear algebra. The quality of the solution in general depends on the quantity and quality of the obtained series of measurements and the type and accuracy of other boundary conditions, which have been established for the stabilization of the approximation-based solution method.

For example, the boundary conditions may determine the properties of the image of the structure of the sample body, wherein the image is obtained by the imaging method. For example, it is common according to Occam's principle that the internal structure of the sample body is assumed as smooth as possible. This assumption has the disadvantage that discrete, sharply defined structures within the sample body are shown smoothed by the imaging method such that the reconstruction of the internal structure of the sample body does not lead to a sharp and discrete internal structure, but to a broad and smooth one.

Further, it is usually necessary to prepare the obtained series of measurements for performing the imaging methods, for example, the run times of ultrasonic waves through the sample body. It is understood that while determining run times on the basis of recorded series of measurements errors can occur, which could destabilize the solution of the inverse problem in the imaging method and which can hardly—if at all—be taken into account in the following.

It is an object of the invention to provide a method and an apparatus which enable the reconstruction of the spatial distribution of a reflection coefficient for waves in a sample body, wherein the spatial extension of the internal structure of the sample body is to be displayed as sharply defined as possible and wherein the evaluation of faulty series of measurements should be performed as easily as possible.

The object is reached by the subject of the independent claims. Preferred embodiments are included in the sub-claims.

### Method According to One Aspect

One aspect of the invention relates to a computer-aided method for reconstructing the spatial distribution of reflection coefficients for waves in a sample body, comprising the following steps:
Parameterizing the sample body by means of N volume elements;
Determining M different measurement configurations of an emitting device for waves and an associated receiving device for waves;
Defining the number T of measurement points, which are registered by the receiving device during a series of measurements to be registered x^{[i ]}ₜ with t ∈ [1, 2, . . . , T] in the i-th measurement configuration with i ∈ [1, 2, . . . , M], wherein the t-th measurement is

performed at a time τ(t);
Setting up M path matrices G^{[i]}, wherein in the i-th path matrix G^{[i]}, the possible paths of reflected and/or scattered waves through the N volume elements of the sample body from the emitting device to the associated receiving device according to the i-th measurement configuration with i ∈ [1, 2, . . . , M] and a run time τ(t) of the wave through the sample body are encoded, wherein the run time is associated with the path;
Registering M series of measurements according to the M different measurement configurations, wherein an excitation signal a^{[i]} is fed to the emitting device in the i-th series of measurements and the associated receiving device registers a series of measurements x^{[i]};
Combining the M series of measurements to a single measurement vector x=(x^{[1]}, x^{[2]} . . . x^{M]})^{T};
Combining the M path matrices G^{[i]} to a single path matrix G=(G^{[1]T}, G^{[2]T} . . . G^{[M]T})^{T};
Initializing N reflection coefficients s^{[n=1]}ⱼ with j ∈ [1, 2, . . . , N] of a reflection coefficient vector s^{[n]} with initial estimates, wherein each reflection coefficient s^{[n]}ⱼ is associated with the j-th volume element of the N volume elements and is constant within the associated volume element;
Calculating a predictive differential vector Δx=x−G·s^{[n]}, which contains the difference between the elements of the M registered series of measurements x^{[i]}ₜ and the predictable series of measurements G^{[i]}ₜⱼ·s^{[n]}ⱼ;
Minimizing a norm of the predictive differential vector ∥Δx∥; and
Providing the reflection coefficients s^{[n]}.

In the present application, matrices are marked by a double underline, for example G, and vectors are marked by a single underline, for example x. Vectors are assumed to be column vectors. It is understood however that after transposing the equations, the vectors can be row vectors as well.

The numbers N, M, and T are all natural numbers greater than zero. In particular, the sample body can be parameterized by N=1, 2, 3, 4, . . . , 32, . . . , 64, . . . , 128, . . . , 256, . . . , 500, . . . , 512, . . . , 1000, . . . , 1024, . . . , 2048, . . . , 4096, . . . 5000, etc. volume elements. Preferably, M=1, 2, 3, 4, 5, 6, 7, 8, 9, 10, . . . , 20, . . . , 30, . . . , 64, . . . , 128, etc. series of measurements can be registered in order to perform the reconstruction. Here, the series of measurements can comprise T=1, 2, 3, 4, . . . , 16, . . . , 32, . . . , 64, . . . , 128, . . . , 256, . . . , 512, . . . , 1024, . . . , 2048, . . . , 4096, etc. individual measurement values. In particular, the number of measurement values can be calculated on the basis of the maximum run time of the wave and the maximum frequency of the wave such that the wave is recorded, i.e. detected or measured by the receiving device, and the reciprocal of the sampling interval is greater than the Nyquist frequency of the wave, for example, 1/(2τ(T)) greater than the maximum frequency contained in the wave.

Under the assumption that the distribution of the reflection coefficients s is sparse, i.e. the reflection coefficient vector s is sparse or the variance of the reflection coefficient vector s is sparse, the requirement of the Nyquist theorem with respect to the minimum sampling interval can be violated, while nevertheless a reconstruction of the reflection coefficient vector s is possible. In this case, the method is in contrast to the technical teachings known to a person skilled in the art, according to which for the digital registration of waves and computer-aided reconstructions, the boundary condition of the Nyquist theorem must be maintained, i.e. the sampling interval for the digital detection of the wave is at least smaller than half of the shortest period of the signals contained in the wave to be detected. In other words, up to now a person skilled in the art has assumed that the sampling frequency must be more than twice the maximum frequency contained in the wave to be detectedm in order to prevent aliasing.

One application of the method of the invention under the boundary conditions that the reflection coefficient vector s is sparse and with sampling intervals which violate the Nyquist theorem, has surprisingly shown that, as expected, the individual series of measurements do not allow an accurate description of the actual wave incident at the receiving device, but nevertheless allow a reconstruction of the reflection coefficients. The reconstruction is as a function of the degree of sparsity of the reflection coefficient vector s likewise possible for underdetermined reconstruction problems. In other words, the number of volume elements N and thus the length of the reflection coefficient vector s can be greater than the product of M·T of the number of measurement configurations and the number of measurement points. Advantageously, it is thus possible to equip the apparatus for performing the method with simpler and less expensive receiving devices. For example, a measurement by means of electromagnetic waves in the gigahertz range, i.e. centimeter waves, can be performed, wherein the at least one receiving device, for example, has to be adapted for the registration of waves in the megahertz range only, whereby advantageously, the costs for more versatile receiving devices can be reduced.

Advantageously, it has been found in the present invention that on the basis of series of measurements—which were obtained in a measurement of a sample body, in particular in a tomographic or fluoroscopic screening—images of the internal structure of the sample body can be generated or reconstructed in a simple and robust manner, wherein advantageously, sharply defined structures result from the reconstruction and wherein advantageously, a complicated processing of the obtained series of measurements, in particular by filtering, is not necessary. This is advantageous, since filtering, in particular using analog filters, for example band-pass filters, takes place with respect to a phase shift of measured signals as a function of the frequency of the signals. Advantageously, a three-dimensional distribution of the reflection coefficient and thus of the structure of the sample body can be reconstructed, which for example have been sampled or measured in violation of Shannon's sampling theorem.

The sample body is parameterized by a number of N volume elements, wherein the individual volume elements may be different from each other with respect to geometric shape and volume. Preferably, the volume elements, however, are arranged regularly. For example, the volume elements may be formed as cuboids such that an orthogonal grid in Cartesian coordinates is spanned by the corner points of the volume elements. Advantageously, a substantially cuboid-shaped sample body can be parameterized in a simple manner by this. For example, the individual volume elements may also have the shape of a hollow cylinder segment, whereby the corner points of the volume elements span an orthogonal grid in cylindrical coordinates. By this, a substantially cylindrical sample body can advantageously be parameterized in a simple manner. Preferably, the sample body is parameterized without any gaps such that each part of the sample body is represented by a volume element. It is understood that the sample body can likewise be parameterized only partially, in particular if only part of the sample body, for example a two-dimensional section, is to be reconstructed.

With each volume element a reflection coefficient sⱼ to be estimated is associated, where j ∈ [1, 2, . . . , N]. The reflection coefficient describes the change of the wave propagation velocity within a volume element compared to the wave propagation velocities of the surrounding volume elements. The reflection coefficient can be defined as the ratio of the wave propagation velocities v₀, vⱼ as follows:

$${s}_{j} = \frac{{v}_{j} - {v}_{0}}{{v}_{j} + {v}_{0}} . \qquad ( 1 )$$

Alternatively, the reflection coefficient may also be defined as the ratio of the wave propagation impedances I₀, Iⱼ or wave resistances as follows:

$${s}_{j} = \frac{{I}_{j} - {I}_{0}}{{I}_{j} + {I}_{0}} = \frac{{ρ}_{j} {v}_{j} - {ρ}_{0} {v}_{0}}{{ρ}_{j} {v}_{j} + {ρ}_{0} {v}_{0}} . \qquad ( 2 )$$

Here, ρⱼ is the density, vⱼ is the wave propagation velocity and Iⱼ is the impedance within the i-th volume element. Accordingly, ρ₀ describes the density, v₀ describes the wave propagation velocity, and I₀ describes the impedance of the material, which surrounds the i-th volume element. The above definition of the reflection coefficients is valid for the incident wave under a perpendicular angle with respect to the interface, which has this reflection coefficient. The interface is defined by means of the parameterization of the contacting boundary surfaces of two volume elements.

The following explanations are based on the assumption that the sample body is penetrated by compression waves or sound waves, such that for the calculation of the reflection coefficients, the compression wave velocity or the sound wave velocity and possibly the mass densities are characterizing. It is understood that for the reconstruction of the internal structure of the sample body, other waves may be used as well. In particular, electromagnetic waves, such as microwaves, can be used. In this case, in order to calculate the reflection coefficient, the propagation velocity or the impedances for microwaves within the sample body have to be used.

For performing the method, the additional assumption is made that the relevant properties of the sample body are constant within each volume element. Furthermore, it is preferably assumed that the wave propagation in the sample body can be approximated at least partly by means of plane waves and beam geometry. More preferably, it is assumed that a beam has a parallel orientation with respect to an edge of the volume element, through which it passes.

In order to realize a sufficient coverage with beam paths in the interior of the sample body, which enables a successful reconstruction of the internal structure of the sample body, M different measurement configurations are determined, which in each case are characterized by a particular geometric position of the emitting device and the receiving device. Determining measurement configurations may comprise a definition or estimation on the basis of other geometric considerations, for example an estimation on the basis of a minimum spatial coverage or a definition as a function of a maximum available measurement time, a maximum processable data volume or a maximum memory size. The path of the wave through the sample body is substantially predetermined by the position of the active emitting device and the active receiving device, wherein deviations from this predetermined path occurring due to the internal structure are preferably neglected in the reconstruction. It is understood that a plurality of differently positioned emitting devices may be used to emit a respective wave from different positions in accordance with the associated measurement configuration. Alternatively, one single emitting device, which will subsequently be arranged in different positions, may be used to emit a respective wave from different positions in accordance with the associated measurement configuration. Analogously, a plurality of differently arranged receiving devices or one single movable receiving device may be used.

The emitting device may be a device for generating mechanical waves, for example a piezoelectric crystal, a speaker, a vibration source, an ultrasound source, etc. Further, the emitting device may be a means for emitting electromagnetic waves, for example, an antenna, an X-ray tube, etc.

For each of these paths according to one of the M different measurement configurations, a path matrix G^{[i ]} is set up, which has the size T times N, where T is the number of measurement points registered by the receiving device and N is the number of volume elements. In other words, the duration of the registration τ(T) at the receiving device is equal to T times a sampling interval Δτ, i.e. the time difference between two measurement points, for example, Δτ=τ(T)−τ(T−1) or Δτ=τ(2)−τ(1).

The path matrix G^{[i]} is sparse, i.e. the individual elements G^{[i]}ₜⱼ with t ∈ [1, 2, . . . , T] and j ∈ [1, 2, . . . , N] are equal to zero, except for the M elements which characterize the path of a reflected or scattered beam or a wave through the N volume elements of the sample body from the emitting device to the associated receiving device in accordance with the i-th measurement configuration when a reflection of the beam or wave occurs at one of the volume elements. A reflection or scattering at the j-th volume element is encoded in the path matrix G^{[i]} such that in the j-th column of the path matrix in a column t, the value “1” or a non-zero value is set, wherein the actual run time τₛ of the reflected beam or the reflected wave through the sample body approximately corresponds to the time τ(t), i.e. |τₛ−τ(t)|=minimum. Column t is dependent on the distance which the beam travels on its path from the emitting device to the receiving device. The approximate run time τ(t) can then be calculated by dividing the distance by an assumed propagation velocity or an average propagation velocity or a real propagation velocity with which the beam propagates. In particular, t may correspond to the number of the volume elements, which are passed on the path of the beam or the wave starting from the emitting device to the j-th volume element and from there to the receiving device. Advantageously, when the sampling interval Δτ is properly selected to set up the path matrices, it is only necessary to count the volume elements passed by the beam. It should be understood that per column of the path matrix G^{[i]}, only one element G^{[i]}ₜⱼ is not equal to zero if multiple reflection is not permitted. Thus, each path matrix G^{[i]} is N-sparse only.

When recording the M series of measurements, the emitting device is fed with an excitation signal a^{[i]} during the execution of the i-th series of measurements. The excitation signal may preferably be a single sine wave, a single half-sine wave, a wavelet, a sweep, or a pulse. In response to the excitation signal a^{[i]} a series of measurements x^{[i]} is registered at the associated receiving device. Under the assumption that the sample body may be considered as a linear system, which is in particular based on the assumption that, during the investigation by means of compression waves only elastic deformation occurs, and during the investigation by means of electromagnetic waves, the attenuation can be neglected, the series of measurements corresponds to the convolution of the pulse response function (i.e. substantially to the structure) of the sample body with the excitation signal. Advantageously, the deconvolution, i.e. the reconstruction of the internal structure of the sample body by means of a linear or at least linearized algebra, is at least approximately possible.

The results of all M series of measurements x^{[i]} are combined to a measurement vector, which is the column vector x with the maximum length M·T. Combining can be described by the operation x=(x^{[1]}, x^{[2]} . . . x^{[M]})^{T}, wherein the operator ( . . . )^{T} is the transpose of the matrix. Furthermore, the individual path matrices G^{[i]} are combined to form a path matrix G, which at most has the dimension of M·T times N. Combining the path matrices can be described by the operation G=(G^{[1]T}, G^{[2]T} . . . G^{[M]T})^{T}. By combining, the reconstruction on the basis of all series of measurements can advantageously be performed simultaneously. Preferably, all elements j of the measurement vector x and all rows j of the path matrix G may be deleted or removed, when the element j of the measurement vector x and all elements in row j of the path matrix G are zero. Thereby, the equation system to be solved for the reconstruction system may be advantageously reduced.

The reconstruction is performed under the assumption that a predetermined spatial distribution of reflection coefficients s is sufficiently close to the actual internal structure of the sample body when by means of the predetermined reflection coefficients s, all actually measured series of measurements x can be predicted or explained with sufficient accuracy. At the beginning of the reconstruction, initial estimates are assigned to the reflection coefficients. Preferably, all reflection coefficients sⱼ are set to zero as a first estimate, which corresponds to a homogeneous sample body. More preferably, known or suspected interfering bodies can be taken into account by assigning a non-zero reflection coefficient to volume elements which represent a known or suspected interfering body.

The predictive differential vector Δx=x−G·s contains the difference between the combined registered series of measurements x or the measurement vector x and the predicted series of measurements G·s. On the one hand, a sufficiently accurate reconstruction of the internal structure of the sample body contained in the vector s is due to a minimization of this difference. Thus, a criterion for a sufficiently accurate reconstruction is the distance between the series of measurements G·s predicted on the basis of the estimated reflection coefficients s and the actually measured series of measurements x, i.e. the norm of the predictive differential vector ∥Δx∥ₚ.

Preferably, minimizing the norm of the predictive differential vector comprises minimizing the Lₚ norm of the predictive differential vector ∥Δx∥ₚ with 0<p≦2. More preferably, the L_{q} norm of the vector of the estimated reflection coefficients ∥s^{[n]}∥_{q} is minimized, where 0<q≦1. Alternatively, the total variance ∥σ(s^{[n]})∥_{q} of the vector of the estimated reflection coefficients may be minimized as well. In other words, the first derivative of the vector of the estimated reflection coefficients s^{[n]} may be minimized, which results in a distribution of the estimated reflection coefficients s^{[n]}, which is partially as constant as possible. Furthermore, instead of the first derivative, the second derivative can be selected for minimizing, which results in a distribution of the estimated reflection coefficients s^{[n]} which is as smooth as possible. In the description below, it is assumed that the norm of the reflection coefficients per se is minimized in order to minimize the number of scattering volume elements. In the light of the foregoing, however, options are included according to which the first and second derivatives are minimized.

In order to perform the reconstruction, the Lₚ norm of the predictive differential vector ∥Δx∥ₚ is minimized under the condition 0<p≦2, wherein said minimization is subject to the boundary condition that the L_{q} norm of the vector of the estimated reflection coefficients ∥s∥_{q} (or its first or second derivative, as outlined above) is minimized as well, wherein 0<q≦1. Here, the vector of the reflection coefficients resulting from the minimization is all the more sparse the smaller q is. Advantageously, sparsity of the resulting vector s of the reflection coefficients leads to a structurally simple reconstructed spatial distribution of the reflection coefficient and thus of the internal structure of the sample body. Advantageously, this results in a simple and sharply defined image of the internal structure of the sample body. Herewith, it is possible to explain the measured series of measurements by means of the resulting reconstructed internal structure of the sample body with as few reflecting or scattering structures as possible.

Providing the reflection coefficients s^{[n]} may comprise in particular outputting the reflection coefficients by means of an output device, a display device and/or a storage device. Preferably, the reflection coefficients may be represented graphically depending on the spatial position of the associated volume elements.

### Preferred Embodiments of the Method

Preferably, the reflection coefficient vector s or the vector of the reflection coefficients sⱼ is minimized such that s is sparse, wherein the number k of the non-zero elements may be predetermined. In particular, all elements of the vector s, which fall below or—for negative values of s—exceed a certain threshold, may be set equal to zero. Preferably, all elements of the vector s may be set equal to zero, except for the k elements having the largest values in magnitude. More preferably, by decreasing the value of q, a stronger sparsity of the vector of the estimated reflection coefficients s may be achieved.

Preferably, minimizing the norm ∥_{Δx∥}ₚ is performed iteratively, wherein iterative minimizing comprises the following steps:
Calculating the predictive differential vector Δx=x−G·s^{[n]} for the n-th iteration;
Calculating an updating vector Δs;
Calculating new reflection coefficient s^{[n+1]}ⱼ=s^{[n]}ⱼ+Δsⱼ.

The individual elements of the predictive differential vector of the n-th iteration of the i-th measurement configuration are Δx^{[i]}ₜ=x^{[i]}ₜ−G^{[i]}ₜⱼ·s^{[n]}ⱼ. The predictive differential vector Δx comprises the differences of all measurement configurations such that the minimization of the difference may be performed at the same time for and taking into account all M series of measurements.

Calculating the updating vector Δs, i.e. the change resulting from the difference between measured and predicted series of measurements in the reflection coefficients, may be performed in different ways. For example, only one element s^{[n]}ⱼ may be changed, wherein preferably the element is selected, which has the greatest effect when minimizing the norm ∥Δx∥ₚ. Further, the updating vector Δs may be determined by a Gaussian solution, wherein Δs is given as:

Δs=(G^{T}G)⁻¹G^{T}Δx, (3)

Here, the operation ( . . . )⁻¹ denotes the matrix inverse. An underdetermined matrix G^{T}G to be inverted may be solved using the pseudo-inverse or Penrose inverse or by using the Marquardt method. By using the updating vector Δs, new reflection coefficients for the next iteration may be calculated by means of s^{[n+1]}ⱼ=s^{[n]}ⱼ+Δsⱼ.

Preferably, the method for iteratively minimizing the distance ∥Δx∥ₚ comprises a step of converting the updating vector Δs to a 2k-sparse updating vector. Here, all elements of the vector Δs are set equal to zero, except for the 2k elements, which have the largest changes in magnitude. Advantageously, thus only the strongest minimizing structures of the internal structure of the sample body are taken into account during the reconstruction.

Preferably, the method for iteratively minimizing the distance ∥Δx∥ₚ comprises a step of converting the newly calculated reflection coefficient vector s^{[n+1]} to a k-sparse vector. Here, all elements of the vector s are set equal to zero, except for the k elements having the largest values in magnitude. Advantageously, thus only the most distinctive structures of the internal structure of the sample body are taken into account during the reconstruction.

Preferably, p equals to 2 such that minimizing the norm ∥Δx∥ₚ is performed by means of the L₂ norm. Advantageously, a very accurate adjustment of the series of measurements is achieved by the L₂ norm. More preferably, p may equal to 1, as advantageously, by using the L₁ norm, the influence of outliers in the detection of the series of measurements is reduced.

Preferably, q equals to 1 such that minimizing the distance ∥Δs∥_{q} is performed by means of the L₁ norm. Advantageously, minimizing by means of the L₁ norm is a convex optimization problem, which especially for a k-sparse vector s may be solved by means of a linearized approach in k·log(M·T) iteration steps.

Preferably, the method comprises the following steps:
Determining T values of the excitation signal a^{[i]}, which is fed to the emitting device during the recording of the i-th series of measurements;
Setting up M excitation signal matrices A^{[i]},

wherein the matrix elements of the first column of the i-th excitation signal matrix A^{[i]} contain the excitation signal a^{[i]},

wherein the matrix elements of the first row of the i-th excitation signal matrix A^{[i]} are equal to zero except for the matrix element A^{[i]}_{1,1}; and

wherein the i-th excitation signal matrix A^{[i]} is a Töplitz matrix;
Combining the M excitation signal matrices A^{[i]} to an excitation signal matrix A=(A^{[1]T}, A^{[2]T} . . . A^{M]T})^{T};
Calculating the predictive differential vector Δx by the rule Δx=x−A·G·s^{[n]}.

Advantageously, the entire measurement signal may be predicted without further pre-filtering, in particular without a Sparse Spike Deconvolution, without Wiener's optimum filtering or without any other filtering, during the reconstruction such that on the one hand, the step of pre-filtering is eliminated and on the other hand, all the information present in the series of measurements is usable for the reconstruction.

Determining the individual values of the excitation signal a^{[i]}ₜ or determining an excitation signal vector a^{[i]} may comprise presetting, calculating or detecting or measuring the values. More preferably, the values of the excitation signal a^{[i]}ₜ also contain the transfer functions of the emitting device and/or of the receiving device. Preferably, a predetermined electronic excitation, for example a rectangular function, a sine wave or any other transient signal which is fed to the emitting device, may be stored in the excitation signal vector a^{[i]}. More preferably, the transfer function of the emitting device, convolved with the signal fed to the emitting device, may be stored in the excitation signal vector a^{[i]}. The convolution may be performed numerically if the transfer function is known. Alternatively, the wave emitted by the emitting device may also be measured and stored in the excitation signal vector a^{[i]}.

More preferably, the transfer function of the receiving device, convolved with the signal fed to the emitting device or with the wave emitted by the emitting device, may be stored in the excitation signal vector a^{[i]}. To this end, the convolution may be performed numerically if the transfer function is known. Alternatively, the wave emitted from the emitting device and directly received by the receiving device may also be measured and stored in the excitation signal vector a^{[i]}. Each of the M excitation signal matrices A^{[i]} is a Töplitz matrix, which means that the elements on a diagonal of the matrix are identical. In other words, the first column of each of the M excitation signal matrices A^{[i]} each comprises the complete excitation signal a^{[i]}, whereas the second column contains an excitation signal shifted down by one line and truncated by a value in the end, etc.

Accordingly, the calculation is performed with the rule Δx=x−A·G·s^{[n]}, wherein the matrix multiplication A·G may already be performed for all iterations in advance and the result may be stored in a further matrix.

### Apparatus According to One Aspect

One aspect of the invention relates to an apparatus for determining the spatial distribution of a reflection coefficient for waves in a sample body, comprising:
at least one emitting device for waves;
at least one receiving device for waves;
at least one sample body receptacle, in which a sample body can at least partially be received such that waves emitted by the at least one emitting device pass at least partially through the sample body on their path to the at least one receiving device;
an evaluation device which is connected to the at least one emitting device and the at least one receiving device, wherein by means of the evaluation device, a method according to the invention can be performed.

In particular, the evaluation device may be part of a computer or a personal computer. Preferably, the evaluation device may comprise a microprocessor or a microcontroller, which is adapted to perform a method according to the invention, i.e., to perform the corresponding calculations. In other words, the evaluation device has the appropriate interfaces to be connected to the at least one emitting device or to the at least one receiving device and in particular to exchange data with them. In particular, the evaluation device has a sufficient data memory, in which data necessary for performing the method according to the invention may be stored. The emitting device and/or the receiving device may contact the sample body mechanically, for example in order to transfer compression waves or sound waves, or may be arranged spaced apart from the sample body, which is the case when in particular electromagnetic waves are used.

### Computer Program Product According to an Aspect

One aspect of the invention relates to a computer program product with a program which is stored on a machine-readable carrier, wherein the program can cause the evaluation device to perform a method according to the invention.

In particular, the machine-readable carrier may be a data carrier, such as a floppy disk, a CD, a DVD, a magnetic tape, a memory module, a memory chip etc. Preferably, the carrier is connectable to the evaluation device, or insertable into the evaluation device in order to provide the program stored on the computer program product for the processor.

### BRIEF DESCRIPTION OF THE DRAWINGS

Hereinafter, preferred embodiments of the present invention will be described with reference to the accompanying drawings.

FIG. 1 shows a preferred embodiment of an apparatus for determining the spatial distribution of a reflection coefficient for waves in a sample body.

FIG. 2 shows a section through a rectangular sample body with an exemplary measurement configuration.

FIG. 3 shows the section through the cuboid sample body with another exemplary measurement configuration.

FIGS. 4a-f show the results of an exemplary reconstruction by means of the inventive method compared to the results obtained by using a known elliptical rear projection.

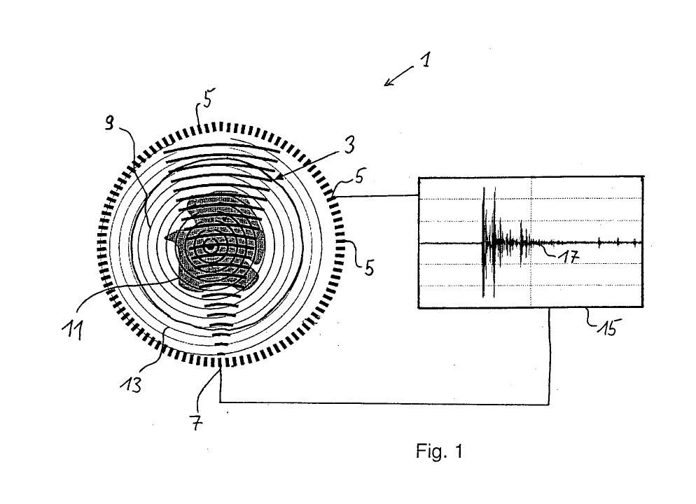

FIG. 1 shows a preferred embodiment of a device 1 for determining the spatial distribution of a reflection coefficient s for waves in a sample body 3. The apparatus 1 includes a sample body receptacle (not shown) in which a cylindrical sample body 3 is at least partially received. Around the shell surface of the cylindrical sample body 3, a plurality of receiving devices 5 is arranged. In cylindrical sample bodies 3, the receiving devices 5 are preferably arranged substantially in a circle around the sample body 3, wherein the center of the circular arrangement of the receiving devices 5 may coincide with the central axis of the cylindrical sample body 3.

The device 1 comprises at least one emitting device 7 for waves. The emitting device 7 is adapted to emit mechanical or electromagnetic waves 9 which penetrate the sample body 3 at least partially. In case of a homogeneous cylindrical sample body 3, the emitted waves 9 would penetrate the sample body 3 essentially rectilinearly. However, the sample body 3 shown in FIG. 1 includes an interfering body 11, which is characterized by an impedance and wave propagation velocity different from those of the surrounding material of the sample body 3. Consequently, the waves 9 which are emitted by the emitting device 7 and which are incident on the interfering body 11, are at least partially reflected or scattered at the interface of the interfering body 11. Each point of this interface of the interfering body 11 can be understood as a starting point of an elementary wave in the sense of the van Huygens principle. The wave 13 reflected from the interfering body 11 may be registered by the receiving devices 5. Preferably, each of the receiving devices 5 can detect the wave emitted by the emitting device 7 and transmitted or reflected through the sample body 3 at the same time or simultaneously. Alternatively, one single receiving device 5 may successively be positioned at different measurement positions such that measurements can be made successively in all of the measurement configurations shown in FIG. 1. Advantageously, the measurement time can be reduced when a plurality of receiving devices 5 is used. On the other hand, the use of one single receiving device, which is repositioned for each sample configuration, enables both a low-cost structure of the device and an increased flexibility of the achievable measurement configurations, since individual receiving devices 5 do not affect each other as a consequence of their spatial shape. Thus, a more dense spatial sampling can be achieved.

More preferably, the emitting device 7 may likewise act as a receiving device 5, and vice versa. For example, an emitting device 7 may be formed as a piezoelectric crystal, which is adapted to convert a voltage signal applied to the piezoelectric crystal to mechanical vibrations, wherein the same piezoelectric crystal may likewise act as a receiving device 5, wherein a mechanical vibration acting on the piezoelectric crystal generates an electric voltage on two sides of the piezoelectric crystal.

As shown in FIG. 1, the at least one emitting device 7 may be connected to an evaluation device 15. The plurality of receiving devices 5 is likewise connected to the evaluation unit 15. At the beginning of a series of measurements, the evaluation device 15 may produce a predetermined excitation signal A and may feed it to the emitting device 7. Furthermore, the evaluation device 15 may start the registration of measurement values at the receiving devices 5 simultaneously or with a slight time delay to feed the excitation signal a^{[i]} to the emitting device 7. After the detection of a predetermined number of T measurement values at the receiving devices 5, the evaluation device 15 can stop the detection of measurement values and perform the transmission of the registered measurement values from the receiving devices 5 to the evaluation device 15. An exemplary series of measurements 17 consisting of T individual measurement values is shown in FIG. 1. After the measurement of the sample body 3 —the measurement consisting of one or more series of measurements—, the evaluation device 15 performs the inventive method for reconstructing the spatial distribution of the reflection coefficient.

It should be understood that instead of the exemplary cylindrical sample body 3, likewise a cuboid or irregularly shaped sample body may be measured by means of the device shown in FIG. 1. Furthermore, it should be understood that the arrangement of the receiving devices 5 and of the at least one emitting device 7 may be realized in other ways, as well. For example, the receiving devices 5 may be arranged rectangularly or with a square shape in a plane. Furthermore, the receiving devices 5 may also be arranged spatially distributed around the sample body 3. In case that the receiving devices 5 and the at least one emitting device 7 have to contact the surface of the sample body 3 due to the selected measuring method, it is understood that the geometric arrangement of the receiving devices 5 and of the emitting device 7 mainly depends on the geometry of the sample body 3.

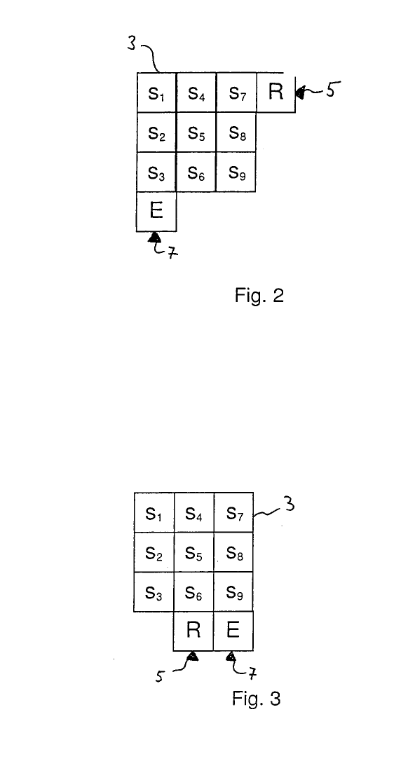

FIG. 2 shows a section through an exemplary square sample body 3, which is parameterized in the section plane by means of nine volume elements and the associated reflection coefficients sⱼ. The clearance between the sample body 3 and the emitting device 7 is determined by the volume element E, and the clearance between the receiving device 5 and the sample body 3 is determined by the volume element R. On the basis of exemplary sample body 3 shown in FIG. 2, setting up the path matrix G^{[1]} is shown for a case in which each of the nine illustrated volume elements s₁ to s₉ may include an interfering body 11. Furthermore, it is also assumed that the wave emitted by the emitting device 7 has the form of a δ pulse or Dirac pulse. The series of measurements registrable at the receiving device 5 is given as x^{[1]}=G^{[1]}·s, wherein the matrix G^{[1]}] only contains zeros and ones due to the previous assumptions.

A reflection at the first volume element having the reflection coefficient s₁ is represented in the path matrix G^{[1]} by setting the value 1 in the first column of the path matrix G^{[1]}, representing in each case the influence of the first volume element, in the sixth row. The sixth row of the path matrix G^{[1]} represents the influence of the sample body on the series of measurements at the time t=6, i.e. the influence on the measurement value x₆ of the series of measurements. This simple assignment can be made under the assumption that both the emitted wave and the reflected wave in each volume element of the sample body as well as in the volume elements E and R, representing the clearance between the sample body and the emitting and receiving devices respectively, substantially have equal size. Particularly when electromagnetic waves, such as microwaves, or compression waves, are used in particular for investigating sample bodies in an immersion liquid by means of ultrasonic waves, this assumption is satisfied sufficiently exactly.

In the case shown in FIG. 2 a wave passes through the volume elements E, s₃ and s₂, before it is incident on the reflecting interfering body at position s₁. The reflected wave then passes through the volume elements s₄, s₇, and R to the receiving device 5. Thus the wave measured at the receiving device 5 passes through six volume elements alltogether under the assumption that each volume element is passed within a time unit which corresponds to the sampling interval Δτ of the series of measurements detected at the receiving device 5. Thus, the wave reaches the receiving device 5 after six time units or after six sampling intervals such that the value s₆ registered there will represent the incidence of the wave using a non-zero value.

Analogously, assuming that each of the other volume elements may have a reflection coefficient s₂ to s₉, the path from the emitting device 7 through the sample body 3 to the receiving device 5 through the volume elements of the sample body 3 may be encoded in the path matrix G^{[1]}. If this procedure is performed for each of the nine positions of the interfering body with the reflection coefficients s₂ to s₉, the following equation is obtained:

$$( \begin{matrix}{x}_{1} \\ {x}_{2} \\ {x}_{3} \\ {x}_{4} \\ {x}_{5} \\ {x}_{6} \\ {x}_{7} \\ {x}_{8} \\ {x}_{9}\end{matrix} ) = ( \begin{matrix}0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 1 & 1 & 0 & 1 & 1 \\ 0 & 1 & 1 & 1 & 0 & 0 & 1 & 0 & 0 \\ 1 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} ) ∘ ( \begin{matrix}{s}_{1} \\ {s}_{2} \\ {s}_{3} \\ {s}_{4} \\ {s}_{5} \\ {s}_{6} \\ {s}_{7} \\ {s}_{8} \\ {s}_{9}\end{matrix} ) \qquad ( 4 )$$

In a preferred embodiment of the reconstruction method, the shape of the excitation signal, which is fed to the emitting device, may be taken into account during the reconstruction of the spatial distribution of the reflection coefficient s. To this end, the individual occurring signals, which have been assumed as δ-pulses in the example shown in FIG. 2, are convolved with the shape of the excitation signal a^{[1]}. This can be achieved in a simple way by a matrix multiplication with an excitation signal matrix A^{[1]}, which has the shape of a Töplitz matrix. Here, the first row of the excitation signal matrix A^{[1]} contains zeroes and the first column of the excitation signal matrix A^{[1]} contains the excitation signal a^{[1]}. As shown in FIG. 2, the system of linear equations shown in equation 4 may be extended by the excitation matrix A^{[1]}, in order to take into account the shape of the registered series of measurements x in the reconstruction. The extended system of linear equations is given by:

$$( \begin{matrix}{x}_{1} \\ {x}_{2} \\ {x}_{3} \\ {x}_{4} \\ {x}_{5} \\ {x}_{6} \\ {x}_{7} \\ {x}_{8} \\ {x}_{9}\end{matrix} ) = ( \begin{matrix}{a}_{1} & 0 & 0 & 0 & 0 & 0 & 0 & 0 & 0 \\ {a}_{2} & {a}_{1} & 0 & 0 & 0 & 0 & 0 & 0 & 0 \\ {a}_{3} & {a}_{2} & {a}_{1} & 0 & 0 & 0 & 0 & 0 & 0 \\ {a}_{4} & {a}_{3} & {a}_{2} & {a}_{1} & 0 & 0 & 0 & 0 & 0 \\ {a}_{5} & {a}_{4} & {a}_{3} & {a}_{2} & {a}_{1} & 0 & 0 & 0 & 0 \\ {a}_{6} & {a}_{5} & {a}_{4} & {a}_{3} & {a}_{2} & {a}_{1} & 0 & 0 & 0 \\ {a}_{7} & {a}_{6} & {a}_{5} & {a}_{4} & {a}_{3} & {a}_{2} & {a}_{1} & 0 & 0 \\ {a}_{8} & {a}_{7} & {a}_{6} & {a}_{5} & {a}_{4} & {a}_{3} & {a}_{2} & {a}_{1} & 0 \\ {a}_{9} & {a}_{8} & {a}_{7} & {a}_{6} & {a}_{5} & {a}_{4} & {a}_{3} & {a}_{2} & {a}_{1}\end{matrix} ) ∘ ( \begin{matrix}0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 1 & 1 & 0 & 1 & 1 \\ 0 & 1 & 1 & 1 & 0 & 0 & 1 & 0 & 0 \\ 1 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} ) ∘ ( \begin{matrix}{s}_{1} \\ {s}_{2} \\ {s}_{3} \\ {s}_{4} \\ {s}_{5} \\ {s}_{6} \\ {s}_{7} \\ {s}_{8} \\ {s}_{9}\end{matrix} ) \qquad ( 5 )$$

Appropriately, the multiplication of the Töplitz matrix which contains the excitation signal, with the path matrix G^{[1]} is performed once at the beginning of the reconstruction method and is cached.

FIG. 3 shows the section shown in FIG. 2 through the sample body 3, wherein the measurement configuration is changed with respect to the positions of the emitting device 7 and of the receiving device 5. The receiving device 5 is arranged directly adjacent to the emitting device 7. Accordingly, reflection coefficients different from 1 in the volume elements characterized by s₆ and s₉ represent a reflection of the emitted wave in the region of the sample body shell. In case that in the volume elements characterized by s₆ and s₉, an interfering body is located, the run time of the reflected wave which is received by the receiving device 5, only corresponds to two sampling intervals ΔT which corresponds to the time required by the registered wave to pass through the volume elements marked by R and E. According to the wave run times of two time intervals, the values of the path matrix G^{[2]} are set to 1 in the second row in the elements of the sixth and ninth columns. As a result, the path matrix G^{[2]} for the measurement configuration shown in FIG. 3 is given by the following equation:

$$( \begin{matrix}{y}_{1} \\ {y}_{2} \\ {y}_{3} \\ {y}_{4} \\ {y}_{5} \\ {y}_{6} \\ {y}_{7} \\ {y}_{8} \\ {y}_{9}\end{matrix} ) = ( \begin{matrix}0 & 0 & 0 & 0 & 0 & 0 & 0 & 0 & 0 \\ 0 & 0 & 0 & 0 & 0 & 1 & 0 & 0 & 1 \\ 0 & 0 & 0 & 0 & 0 & 0 & 0 & 0 & 0 \\ 0 & 0 & 1 & 0 & 1 & 0 & 0 & 1 & 0 \\ 0 & 1 & 0 & 0 & 0 & 0 & 0 & 0 & 0 \\ 0 & 0 & 0 & 1 & 0 & 0 & 1 & 0 & 0 \\ 1 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0\end{matrix} ) ∘ ( \begin{matrix}{s}_{1} \\ {s}_{2} \\ {s}_{3} \\ {s}_{4} \\ {s}_{5} \\ {s}_{6} \\ {s}_{7} \\ {s}_{8} \\ {s}_{9}\end{matrix} ) , \qquad ( 6 )$$

Here, the series of measurements, which corresponds to the measured series of measurements x^{[2]}, is denoted in a different way with y. In order to perform the reconstruction of the distribution of the reflection coefficient s in the sample body 3 on the basis of two different measurement configurations which are shown in FIGS. 2 and 3, the series of measurements x^{[1]} and y (corresponding to x^{[2]}) as well as the associated path matrices G^{[1]} and G^{[2]} are combined to a system of linear equations. As due to the zero rows in the path matrices G^{[1]} and G^{[2]} the systems of linear equations 4 and 6 contain equations, which do not contribute to the solution of the system, these rows may be removed from the system of linear equations. After removing the irrelevant equations or rows from the system of equations, the system of linear equations to be solved may be written as follows:

$$( \begin{matrix}{x}_{4} \\ {x}_{5} \\ {x}_{6} \\ {y}_{2} \\ {y}_{4} \\ {y}_{5} \\ {y}_{6} \\ {y}_{7}\end{matrix} ) = ( \begin{matrix}0 & 0 & 0 & 0 & 1 & 1 & 0 & 1 & 1 \\ 0 & 1 & 1 & 1 & 0 & 0 & 1 & 0 & 0 \\ 1 & 0 & 0 & 0 & 0 & 0 & 0 & 0 & 0 \\ 0 & 0 & 0 & 0 & 0 & 1 & 0 & 0 & 1 \\ 0 & 0 & 1 & 0 & 1 & 0 & 0 & 1 & 0 \\ 0 & 1 & 0 & 0 & 0 & 0 & 0 & 0 & 0 \\ 0 & 0 & 0 & 1 & 0 & 0 & 1 & 0 & 0 \\ 1 & 0 & 0 & 0 & 0 & 0 & 0 & 0 & 0\end{matrix} ) ∘ ( \begin{matrix}{s}_{1} \\ {s}_{2} \\ {s}_{3} \\ {s}_{4} \\ {s}_{5} \\ {s}_{6} \\ {s}_{7} \\ {s}_{8} \\ {s}_{9}\end{matrix} ) . \qquad ( 7 )$$

Thus, the size of the system of linear equations to be solved may advantageously be reduced to what is necessary.

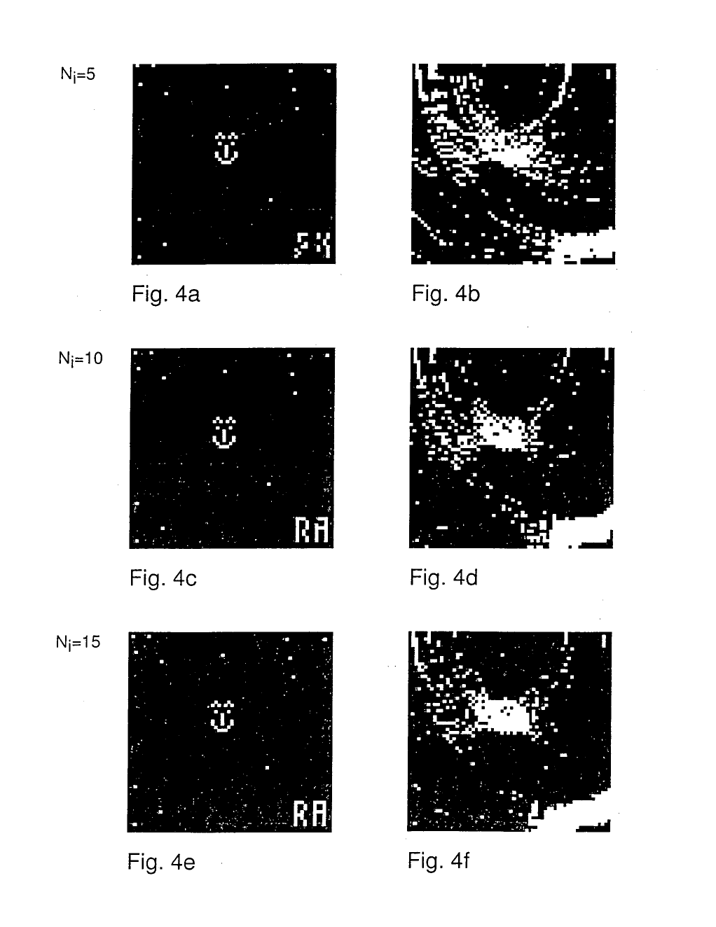

FIGS. 4a-4f show the results of an exemplary reconstruction by means of the method of the invention compared to the results obtained by means of the known “Synthetic Aperture Focussing Technique” (SAFT) or an elliptical rear projection.

FIGS. 4a and 4b show the results of the reconstruction using M=5 series of measurements x. The series of measurements x may be convolved with the transfer function of the whole measurement system, i.e. the excitation signal a as well as the pulse response function of the emitting device and the pulse response function of the receiving device, wherein during the reconstruction, this convolution must likewise be performed as described with respect to equation (5), in order to be able to adapt the series of measurements completely. During the reconstruction or the optimization included in it, the deconvolution of the series of measurements takes place as well.

A comparison between the reconstruction results shown in FIG. 4a and obtained by means of the inventive method and the result shown in FIG. 4b, which was obtained by means of an elliptical rear projection, shows that a relatively small number of series of measurements is already sufficient, to resolve structures in the core region of a sample body by means of the method according to the invention. In contrast to this, only two anomalous regions are detectable based on the reconstruction shown in FIG. 4b, but these are not resolvable.

FIGS. 4c and 4d show the results of the reconstruction using an increased number of M=10 series of measurements x. While the method of the invention, as shown in FIG. 4c, almost completely resolves one further anomaly in the lower right edge region of the sample body, the reconstruction result shown in FIG. 4d improves only slightly.

FIGS. 4e and 4f show the results of the reconstruction using an even more increased number of M=15 series of measurements x. The method of the invention completely resolves, as shown in FIG. 4e, the two anomalies existing in the sample body. In contrast to this, the elliptical rear projection may at most detect the two anomalies, but may not resolve the structure of these anomalies, as shown in FIG. 4f.

### List of Reference Numbers

1 device

3 sample body

5 receiving device for waves

7 emitting device for waves

9 emitted wave

11 interfering body

13 reflected wave

15 evaluation device

17 series of measurements

1. A computer-aided method for reconstructing the spatial distribution of reflection coefficients for waves in a sample body, comprising the following steps:
Parameterizing the sample body by means of N volume elements;
Determining M different measurement configurations of an emitting device for waves and an associated receiving device for waves;
Defining a number T of measurement points, which are registered by the receiving device during a series of measurements to be registered x^{[i]}ₜ with t∈[1, 2, . . . , T] in the i-th measurement configuration with i∈[1, 2, . . . , M], wherein the t-th measurement is performed at a time τ(t);
Setting up M path matrices G^{[i]}, wherein in the i-th path matrix G^{[i]}, the possible paths of reflected and/or scattered waves through the N volume elements of the sample body from the emitting device to the associated receiving device according to the i-th measurement configuration with i ∈ [1, 2, . . . , M] and a run time τ(t) of the wave through the sample body are encoded, wherein the run time is associated with the path;
Registering M series of measurements according to the M different measurement configurations, wherein an excitation signal a^{[i]} is fed to the emitting device in the i-th series of measurements and the associated receiving device registers a series of measurements x^{[i]};
Combining the M series of measurements to a single measurement vector x=(x^{[1]}, x^{[2]} . . . x^{[M]})^{T};
Combining the M path matrices G^{[i]} to a single path matrix G=(G^{[1]T}, G^{[2]T} . . . G^{[M]T})^{T};
Initializing N reflection coefficients sⁿ⁼¹ⱼ with j ∈ [1, 2, . . . , N] of a reflection coefficient vector s^{[n]} with initial estimates, wherein each reflection coefficient s^{[n]}ⱼ is associated with the j-th volume element of the N volume elements and is constant within the associated volume element;
Calculating a predictive differential vector Δx=x−G·s^{[n]}, which contains the difference between the elements of the M registered series of measurements x^{[i]}ₜ and the predictable series of measurements G^{[i]}ₜⱼ·s^{[n]}ⱼ;
Minimizing a norm of the predictive differential vector ∥Δx∥; and
Providing the reflection coefficients s^{[n]}.

2. A method according to claim 1, wherein the minimization is performed using an Lₚ norm of the predictive differential vector ∥Δx∥ₚ with 0<p≦2, wherein an L_{q} norm of the vector of the reflection coefficients ∥s^{[n]}∥_{q} is minimized where 0<q≦1 .

3. A method according to claim 1, wherein the minimization is performed using an Lₚ norm of the predictive differential vector ∥Δx∥ₚ with 0<p≦2, wherein an L_{q} norm of the total variance of the vector of reflection coefficients ∥σ(s^{[n]})∥_{q} is minimized where 0<q≦1.

4. A method according to claim 1, wherein a reflection coefficient vector s is minimized such that s is sparse, wherein the number k of the non-zero elements can be predetermined.

5. A method according to claim 1, wherein the minimization of the norm ∥Δx∥ₚ is performed iteratively wherein the iterative minimization comprises the following steps:
Calculating the predictive differential vector Δx=x−G·s^{[n]} for the n-th iteration;
Calculating an updating vector Δs;
Calculating a new reflection coefficient vector s^{[n+1]}=s^{[n]}+Δs.

6. A method according to claim 5, wherein the iterative minimization of the distance ∥Δx∥ₚ comprises the following steps:
Converting the updating vector Δs to a 2k-sparse updating vector.

7. A method according to claim 5, wherein the iterative minimization of the distance ∥Δx∥ₚ comprises the following steps:
Converting the newly calculated reflection coefficient vector s^{[n+t]} to a k-sparse vector.

8. A method according to claim 2, wherein p=2, such that the minimization of the norm ∥Δx∥ₚ is performed using an L₂ norm.

9. A method according to claim 2, wherein q=1, such that minimization of the norm ∥Δs∥_{q} is performed using an L₁ norm.

10. A method according to claim 1, comprising the following steps:
Determining T values of the excitation signal a^{[i]}, which is fed to the emitting device during the recording of the i-th series of measurements;
Setting up M excitation signal matrices A^{[i]},
wherein the matrix elements of the first column of the i-th excitation signal matrix A^{[i]} contain the excitation signal a^{[i]},
wherein the matrix elements of the first row of the i-th excitation signal matrix A^{[i]} are equal to zero except for the matrix element A^{[i]}_{1,1}; and
wherein the i-th excitation signal matrix A^{[i]} is a Toeplitz matrix;
Combining the M excitation signal matrices A^{[i]} to an excitation signal matrix A=(A^{[1]T}, A^{[2]T} . . . A^{[M]T})^{T}; and
Calculating the predictive differential vector Δx by the rule Δx=x−A·G·s^{[n]}.

11. An apparatus for determining the spatial distribution of a reflection coefficient for waves in a sample body, comprising:
at least one emitting device for waves;
at least one receiving device for waves;
at least one sample body receptacle, in which a sample body can at least partially be received such that waves emitted by the at least one emitting device pass at least partially through the sample body on their path to the at least one receiving device; and
an evaluation device which is connected to the at least one emitting device and the at least one receiving device, wherein the evaluation device is configured to:
parameterize the sample body by means of N volume elements;
determine M different measurement configurations of an emitting device for waves and an associated receiving device for waves;
define a number T of measurement points, which are registered by the receiving device during a series of measurements to be registered x^{[i]}ₜ with t∈[1, 2, . . . , T] in the i-th measurement configuration with i∈[1, 2, . . . , M], wherein the t-th measurement is performed at a time τ(t);
set up M path matrices G^{[i]}, wherein in the i-th path matrix G^{[i]}, the possible paths of reflected and/or scattered waves through the N volume elements of the sample body from the emitting device to the associated receiving device according to the i-th measurement configuration with i ∈ [1, 2, . . . , M] and a run time τ(t) of the wave through the sample body are encoded, wherein the run time is associated with the path;
register M series of measurements according to the M different measurement configurations, wherein an excitation signal a^{[i]} is fed to the emitting device in the i-th series of measurements and the associated receiving device registers a series of measurements x^{[i]};
combine the M series of measurements to a single measurement vector x=(x^{[1]}, x^{[2]} . . . x^{M]})^{T};
combine the M path matrices G^{[i]} to a single path matrix G=(G^{[1]T}, G^{[2]T} . . . G^{[M]T})^{T};
initialize N reflection coefficients s^{[n=1}ⱼ with i ∈ [1, 2, . . . , N] of a reflection coefficient vector s^{[n]} with initial estimates, wherein each reflection coefficient s^{[n]}ⱼ is associated with the i-th volume element of the N volume elements and is constant within the associated volume element;
calculate a predictive differential vector Δx=x−G·s^{[n]}, which contains the difference between the elements of the M registered series of measurements x^{[i]}ₜ and the predictable series of measurements G^{[i]}ₜⱼ·s^{[n]}ⱼ;
minimize a norm of the predictive differential vector ∥Δx∥; and
provide the reflection coefficients s^{[n]}.

12. A computer program product with a program which is stored on a machine-readable medium and executable by an evaluation device of an apparatus for determining the spatial distribution of a reflection coefficient for waves in a sample body to perform a method comprising:
parameterizing the sample body by means of N volume elements;
determining M different measurement configurations of an emitting device for waves and an associated receiving device for waves;
defining a number T of measurement points, which are registered by the receiving device during a series of measurements to be registered x^{[i]}ₜ with t∈[1, 2, . . . , T] in the i-th measurement configuration with i∈[1, 2, . . . , M], wherein the t-th measurement is performed at a time τ(t);
setting up M path matrices G^{[i]}, wherein in the i-th path matrix G^{[i]}, the possible paths of reflected and/or scattered waves through the N volume elements of the sample body from the emitting device to the associated receiving device according to the i-th measurement configuration with i ∈ [1, 2, . . . , M] and a run time τ(t) of the wave through the sample body are encoded, wherein the run time is associated with the path;
registering M series of measurements according to the M different measurement configurations, wherein an excitation signal a^{[i]} is fed to the emitting device in the i-th series of measurements and the associated receiving device registers a series of measurements x^{[i]};
combining the M series of measurements to a single measurement vector x=(x^{[1]}, x^{[2]} . . . x^{[M]})^{T};
combining the M path matrices G^{[i]} to a single path matrix G=(G^{[1]T}, G^{[2]T} . . . G^{[M]T})^{T};
initializing N reflection coefficients s^{[n=1]}ⱼ with j ∈ [1, 2, . . . , N] of a reflection coefficient vector s^{[n]} with initial estimates, wherein each reflection coefficient s^{[n]}ⱼ is associated with the i-th volume element of the N volume elements and is constant within the associated volume element;
calculating a predictive differential vector Δx=x−G·s^{[n]}, which contains the difference between the elements of the M registered series of measurements x^{[i]}ₜ and the predictable series of measurements G^{[i]}ₜⱼ·s^{[n]}ⱼ;
minimizing a norm of the predictive differential vector ∥Δx∥; and
providing the reflection coefficients s^{[n]}.
